(19) United States
(12) Patent Application Publication
(10) Pub. No.: US 2003/0229610 A1
(43) Pub. Date: Dec. 11, 2003

(54) Simpler and more concise interface to relational databases

(76) Inventor: George Michael Van Treeck, Alameda, CA (US)

Correspondence Address: George M. Van Treeck, 668 Westline Dr., Alameda, CA, 94501, US

(21) Appl. No.: 10/165,780

(22) Filed: Jun. 7, 2002

(51) Int. Cl. G06F 7/00

(52) U.S. Cl. 707/1

(57) ABSTRACT

A method and apparatus for a person to create tables in a relational database and use a relational database while maintaining referential integrity without explicitly specifying primary keys, foreign keys, referential integrity constraints on foreign keys, and common columns. A new column data type, link, combined with a link column naming method is used to implicitly identify the primary key, foreign keys and primary key referenced by each foreign key. Primary key values are automatically generated and immutable. Foreign key values are only set via implicit common columns. A table-level cascade delete constraint declaration is part of the definition of a parent table.

### BACKGROUND OF THE INVENTION

1. Field of the Invention

The present invention relates to relational databases, and more particularly to the method and apparatus of defining and using relational databases at a higher level of abstraction that eliminates the need to specify such lower level implementation details as primary keys, foreign keys, referential integrity constraints on foreign keys and common columns.

2. Description of the Prior Art

A characteristic of data stored in a relational database is whether the database has referential integrity (RI). Referential integrity refers to the logical consistency of data in a database, where every foreign key references a valid primary key.

For example, product X is removed from a products table. But product X is still listed in an inventory table. The row containing product X in the inventory table is called an orphan row because it no longer references a valid product. Thus, the database has a logical data inconsistency.

Constraints must be imposed on what changes can be made and in what order the changes can be made in tables to maintain RI. In the prior art, most RI constraints are specified on the foreign key.

A foreign key is one or more columns in the row of a table comprising a value that matches the value of a primary key. One or more columns in the row of table comprises a unique row lookup value are called a primary key. A foreign key with a value matching the value of primary key is said to reference the primary key.

The table containing the primary key is called the parent table. And the table containing the foreign key column is the child table, because the child table's data logically depends on the data in the parent table. When modeling the relationship between the child table and parent table using entity-relation (ER) diagrams, the relation between two tables is sometimes called a “link”.

When the person defining the tables of a relational database specifies the primary keys, foreign keys and the RI constraints on each foreign key, then some implementations of relational database management systems (RDBMS) have methods and apparatus to enforce the RI constraints that ensure that data remains logically consistent. If the RDBMS lacks the ability to detect, check and enforce RI constraints, then a person must develop software to check and enforce the RI constraints.

Highly skilled individuals often create relational databases with many tables that are prone to logical inconsistencies known as update anomalies and orphan rows due to human error in the design of the database. They forget to identify a column as a foreign key. They forget to assert RI constraints on some of the foreign keys. Or they have defects in the software they developed to check and enforce RI constraints.

To maintain RI, the prior art requires the person defining tables in a database to explicitly specify the primary keys, foreign keys and RI constraints. The prior art lacks a means to automate detection of primary keys, foreign keys and RI constraints to eliminate the human error in the design of relational databases resulting in lost RI.

The prior art of developing software applications with many database tables requires a level skill beyond that of the average person. A major reason for this limitation is that the prior art requires a significant level of skill to design a normalized database, assert RI constraints, and write the software to enforce RI constraints.

The prior art lacks a means whereby someone less skilled can specify the data columns in table, state that one table uses another table without going into further detail and have software automatically detect all dependencies and automate assertion of RI constraints based on those dependencies. Development of software applications containing many database tables by less skilled people requires that a person should not have to specify primary keys, foreign keys, RI constraints and develop software to enforce constraints.

Getting the correct medication and dosage from a pharmacy depends on the RI of relational databases. National security depends on the RI of relational databases. Many business operations depend on the RI of relational database. Thus, loss of RI in a database can have catastrophic consequences. Therefore, it is very useful even for highly skilled database designers to have a method and apparatus to guarantee logical consistency of data by automating detection of all dependencies, automate the assertion of all required RI constraints and automatically enforce all RI constraints.

However, the prior art has several fundamental flaws that make it impossible to define and use a relational database while maintaining logical consistency of data without specifying low level details such as the primary keys, foreign keys, and RI constraints on foreign keys.

The first flaw in the prior art is that there are no intrinsic properties of a table column that allows implicit detection of primary keys, foreign keys, and the primary key referenced by each foreign key. Thus, the person defining a table must explicitly specify which columns contain primary keys, which columns contain the foreign keys, and specify the primary key referenced by each foreign key. This invention remedies this flaw.

The second flaw is that the prior art is focused on detecting and enforcing RI constraints rather than preventing the need for RI constraints in the first place. There are many patents on detecting and enforcing RI constraints. Further, there is much on-going research into detecting and enforcing RI constraints, because the prior art still fails to detect and enforce all RI constraints. And, performance of a database management system is significantly reduced by the overhead of constraint detection, checking and enforcement. This invention remedies this flaw.

The third flaw of the prior art requires the person designing a database to explicitly specify all the RI constraints for every foreign key, which creates the potential of the human error of forgetting to assign an RI constraint such as cascade delete on some foreign keys. This invention remedies this flaw.

A fourth flaw of the prior art requires a person to specify data definitions, database queries and data manipulation which are unnecessarily complex and verbose. This invention provides some remediation for this flaw.

The remedy of these flaws in the prior art provide a means for people to work at a higher level of abstraction when defining and using relational databases, where people can define and use a relational database while maintaining logical consistency of data without specifying primary keys, foreign keys, referential integrity constraints on foreign keys, and common columns.

### BRIEF SUMMARY OF THE INVENTION

It is the object of the present invention to provide a means for people to work at a higher level of abstraction when defining and using relational databases, where people can define and use a relational database while maintaining referential integrity (RI) without specifying primary keys, foreign keys, RI constraints on foreign keys, and common columns.

It is another object of this invention to simplify both data definition languages (DDL) and data manipulation languages (DML) of the current art. And, it is another object of this invention to significantly improve overall speed of a relational database management system (RDBMS).

Additional objects, advantages and novel features of the invention will be set forth in part in the description that follows, and in part will become apparent to those skilled in the art of developing an RDBMS of the following, or may be learned by the practice of the invention. The objects and advantages of the invention may be realized and attained by means of the instrumentalities and in combinations particularly pointed out in the appended claims.

In achieving these and other objects, a method and apparatus has been provided for defining and using relational databases while maintaining logical consistency of data without specifying primary keys, foreign keys, and referential integrity (RI) constraints on foreign keys.

This invention comprises six components:

The first component of this invention eliminates the need to explicitly specify the primary key, foreign keys, and the primary key referenced by each foreign key in a table. This first component of this invention is a method and apparatus comprising: a new column type, link, which only contains keys; a column naming method for link columns is added to the prior art, where: a primary key column is assigned the same name as the name of the table containing the primary key column; and a foreign key column is assigned the same name as the name of the referenced primary key column; and software that uses the link column type and link column naming convention to infer the primary key, foreign keys and primary key referenced by each foreign key.

The prior art of checking column names combined with the link column naming method is applied to infer which keys are primary keys, which keys are foreign keys and the reference of each foreign key. Thus, explicit specification of which columns contain primary keys, which columns contain the foreign keys, and the primary key referenced by each foreign key is no longer necessary because it is inferred from the column type and link column naming method.

For example, a table named “Employee” would have a primary key named “Employee”. If table “AssignedEmployee” has a link column named “Employee”, then the “Employee” column is a foreign key column referencing the primary key “Employee” in the table “Employee”.

FIG. 1 is a Backus-Naur-Form (BNF) definition of a table with the link column identifier syntax 2. Note the syntax of the prior art for identifying primary keys, foreign keys, and primary key referenced by each foreign key on foreign keys are not present in this BNF table definition because they are no longer necessary in a DDL and DDL parser of this invention.

The preferred embodiment of the link data type is a fixed length, binary integer field. A single fixed-length data type allows for automated generation of all primary key values. A single fixed-length data type for all keys allows search and read-write optimizations that significantly improve overall database performance.

The second component of this invention is a method and apparatus providing a simpler and more concise DDL comprising: the methods and apparatus of the first component of this invention and computer software that implicitly adds the primary key to a table definition when the primary key is not explicitly defined as part of the table definition.

The third component of this invention is a method and apparatus providing RI on row insert and row update without the need for RI constraint detection, checking and enforcement, comprising: the automatic assignment of a unique value to each and every primary key; updates of a row that would change the value of a primary key are not allowed; only allowing the value of a foreign key to be set to the value of an implicit common column projected from a relational operation; setting an implicit not-NULL constraint on all foreign key columns.

The combination of steps in this component prevent all update anomalies and orphan rows caused by a row insert or row update. Guaranteed RI on all row inserts and updates eliminates the need for RI constraint checking and enforcement. Eliminating the RI constraint checking and enforcement improves RDBMS performance.

The fourth component of this invention provides RI on row deletion without specifying RI constraints on each foreign key, comprising: the first component of this invention; a not-NULL constraint on all foreign keys; adding a table-level cascade delete constraint attribute to the definition of a table; and row deletion maintaining RI, where row deletion maintaining RI further comprises: checking the metadata in the RDBMS to determine if cascading delete is allowed on a table; identifying the child tables by query of the RDBMS; locating any dependent rows in the child tables; if cascading delete is allowed, then deleting the row and all dependent rows; if cascading delete is not allowed and no dependent rows exist, then deleting the row.

This eliminates the potential for human error in forgetting to specify an RI constraint on each foreign key of all child tables or specifying inconsistent RI constraints. This also simplifies the DDL. And it eliminates the overhead of constraint consistency checking each time a child table is added to the database.

FIG. 1 shows the Backus-Naur-Form (BNF) definition of the prior art of a structured query language (SQL) DDL extended with the link column declaration 2 and cascade delete declaration 1. Note that the specification of RI constraints such as “ON DELETE CASCADE” and “ON DELETE SET NULL” on foreign keys used in the prior art are absent from the DDL in FIG. 1, because this invention makes them unnecessary.

The fifth component of this invention is a method and apparatus providing simpler and more concise database queries in a DML comprising: the methods and apparatus of the first component of this invention and the step of all link columns with the same name are implicit common columns in all relational operations and all derived relational operations.

The sixth component of this invention is a method and apparatus making row insert, update and delete commands in a DML simpler and more concise, comprising: the methods and apparatus of the fifth component of this invention and the step of all relational operations implicitly project all the link columns.

The following is the SQL definition of a table of employees assigned to departments using this invention:

------------------------------------------------------------------------------------------------------

CREATE TABLE AssignedEmployee {

Department LINK,
Employee LINK UNIQUE

}

------------------------------------------------------------------------------------------------------
Whereas, the prior art requires a more complex and less concise SQL equivalent:
------------------------------------------------------------------------------------------------------

CREATE TABLE AssignedEmployee {

AssignmentID INTEGER PRIMARY KEY,
DepartmentID INTEGER NOT NULL,
EmployeeID INTEGER UNIQUE NOT NULL,
FOREIGN KEY (DepartmentID) REFERENCES Department (ID),
FOREIGN KEY (EmployeeID) REFERENCES Employye (ID)

ON DELETE CASCADE

}

------------------------------------------------------------------------------------------------------

As can be seen from the example above, the components of this invention make the DDL much simpler and much more concise. The prior art requires working at a much lower level of detail. People defining tables at this lower level of detail are less productive and their database designs more likely to have flaws that result in lost RI.

It is the combination of the components of this invention that allow a person to define tables and manipulate data without having to know about such concepts as primary keys, foreign keys and referential integrity constraints, because these are provided implicitly by the method and apparatus.

For those skilled at database design, this invention greatly enhances their productivity, because it frees database designers to focus more of their time thinking about what table data and relationships they want in their database rather than thinking about how to identify and enforce RI constraints.

### BRIEF DESCRIPTION OF THE DRAWINGS

The accompanying drawings, which are incorporated herein and form a part of the specification and together with the description, serve to explain the principles of the invention. In the drawings:

FIG. 1 is a BNF description of a modified SQL data definition language for defining tables comprising a part of this invention. Specifically it adds the syntax for a link column 2 and a table-level, cascade delete constraint 1.

FIG. 2 is a class inheritance diagram showing how various table column classes inherit from Column class.

FIG. 3 is a translation from the class inheritance diagram of FIG. 2 into a more detailed embodiment in the Java programming language defining a generic column metadata class.

FIG. 4 is a translation from the class inheritance diagram of FIG. 2 into a more detailed embodiment in the Java programming language showing in more detail how a Link column 20 is a type of BigInt column.

FIG. 5 is a translation from the class inheritance diagram of FIG. 2 into a more detailed embodiment in the Java programming language showing how a BigInt 31 is a type of Column.

FIG. 6 is an embodiment in the Java programming language showing how a data structure comprising an array of columns is converted into both a SQL table definition of the prior art and a SQL table definition of this invention.

FIG. 7 is an embodiment in the Java programming language showing the steps to implicitly create a primary key when one has not been explicitly specified in a table definition.

### DETAILED DESCRIPTION OF THE INVENTION

This invention is a method and apparatus to provide a means for people to work at a higher level of abstraction when defining and using relational databases, where people can define and use a relational database while maintaining logical consistency of data without specifying primary keys, foreign keys, referential integrity (RI) constraints on foreign keys, and common columns.

The preferred embodiment is comprised of components embedded within data definition languages (DDL), data manipulation languages (DML), and relational database management systems (RDBMS) of the prior art. In the description herein, the term, “user”, is a person or computer software which interacts with this invention using the prior art of interfaces to an RDBMS.

The preferred embodiment is for the software components of this invention to be an embedded part of an RDBMS. As an embedded part of the RDBMS, the software would use internal programming interfaces to interact with the various components of the RDBMS.

A variation of the embodiment is for the software components of this invention to be a front-end to an RDBMS of the prior art, where the user interacts with the software and the software then interacts with the RDBMS, in such a manner that the software appears to the user as an RDBMS. The front-end software would use a programming interface to an RDBMS including but not limited to Open Database Connectivity (ODBC) and Java Database Connectivity (JDBC).

This invention comprises six components, which make the defining and using a relational database management system simpler and more concise, while maintaining referential integrity.

The first component is a method and apparatus providing a means of defining tables without explicitly specifying the primary keys, foreign keys, and primary keys referenced by each foreign key, comprising: a new column data type added to the to the current DDL art, herein referred to as a link column, which only contains key values; a column naming method for link columns is added to the current DDL art, where: a primary key column is assigned the same name as the name of the table containing the primary key column; a foreign key column is assigned the same name as the name of the referenced primary key column; and software that uses the link column type and link column naming convention to infer the primary key, foreign keys and primary key referenced by each foreign key.

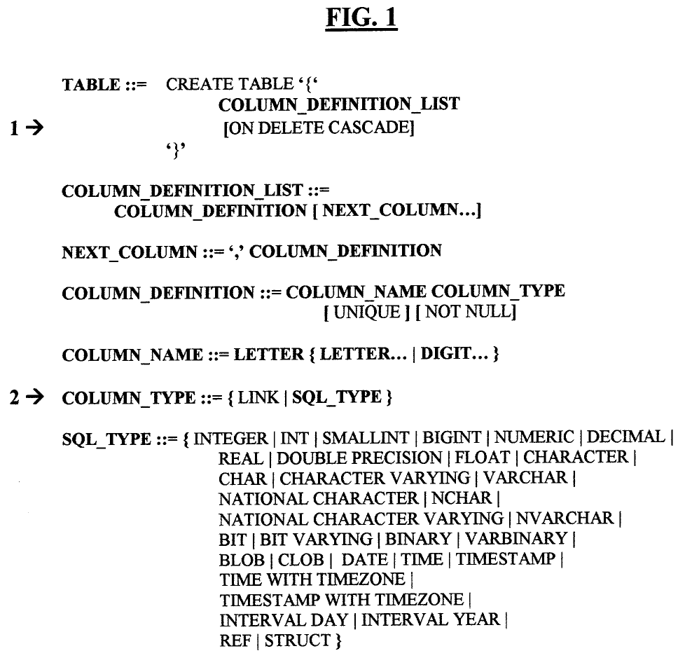

The link column is embodied as the addition of a link column identifier to a DDL of the prior art. The embodied syntax for the link column in a DDL depends on the DDL used. FIG. 1 shows an embodiment of link column syntax 2 in a structured query language (SQL), described in Backus-Naur-Form (BNF). Symbols and conventions used to express the BNF are: brackets, “[ ]”, enclose optional items; braces, “{ }”, enclose items where only one which is required; a vertical bar, “|”, separates alternatives; an ellipsis, “ . . . ”, indicates the preceding syntax element can be repeated; all non-alphanumeric syntax is enclosed in single quotes, “‘”; words in bold are place holders for which a substitute value is defined, words that are not boldface are keywords.

The embodiment in FIG. 1 uses the column identifier “LINK” 2. However, any unique identifying word can be used to represent a link column in a textual DDL. Examples of alternative embodiments of a link column identifier are: “REFERENCE”, “USES” and “ASSOCIATION”. Likewise, any unique picture icon can be used to represent a link column in a graphical DDL.

The link column identifier syntax, replaces the syntax for specifying primary keys, foreign keys, and reference of each foreign key in a DDL. The DDL parser recognizes both the syntax and semantics of the link column. Specification of primary keys, foreign keys, and reference of each foreign key in a DDL of the prior art are absent from the DDL of this improvement because they are no longer needed. Adding recognition of the syntax and semantics of a new column type in parsers and translators is well understood in the prior art.

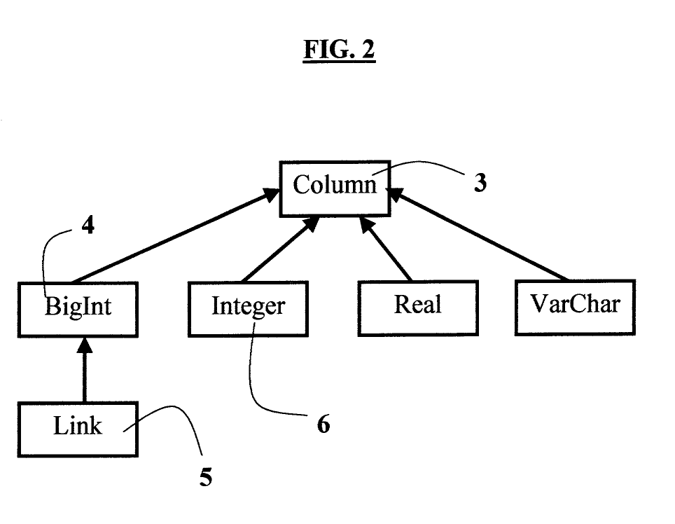

FIG. 2 is an object-oriented class inheritance diagram showing a generic Column class 3. The preferred physical embodiment of a link column within an RDBMS is the extension of a binary integer column of the prior art with sufficient number of bits to guarantee a unique value for each primary key in a table. The 64 bit binary integer type, BIGINT, in SQL is large enough for all current implementations of a RDBMS. The embodiment of this is shown at a high level in FIG. 2, where Link 5 inherits from BigInt 4. An alternative embodiment is Link 5 inheriting from Integer 6 if the RDBMS does not allow a table with more than two billion rows. If the RDBMS does not support the BIGINT column type, then another integer type provided by the RDBMS would be used such as the SQL data type “NUMERIC(19,0)”.

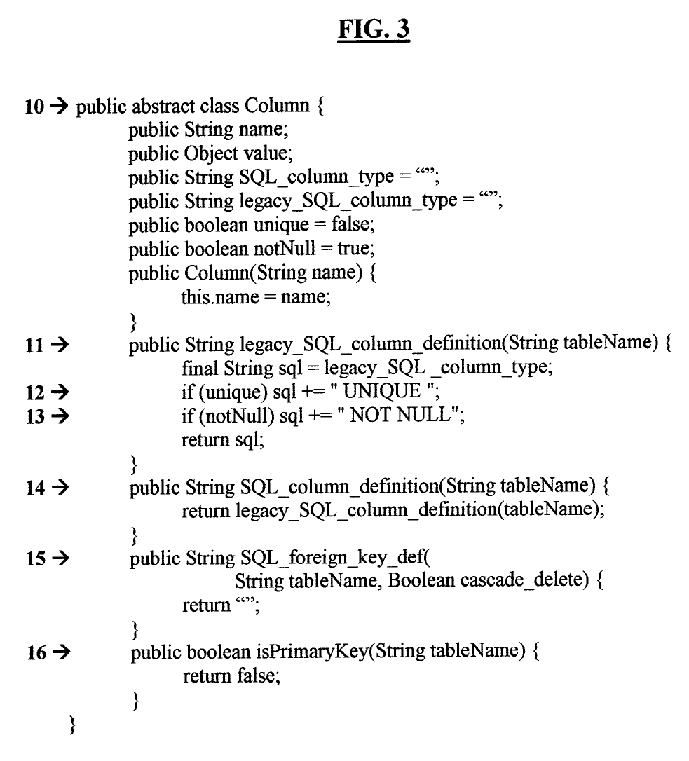

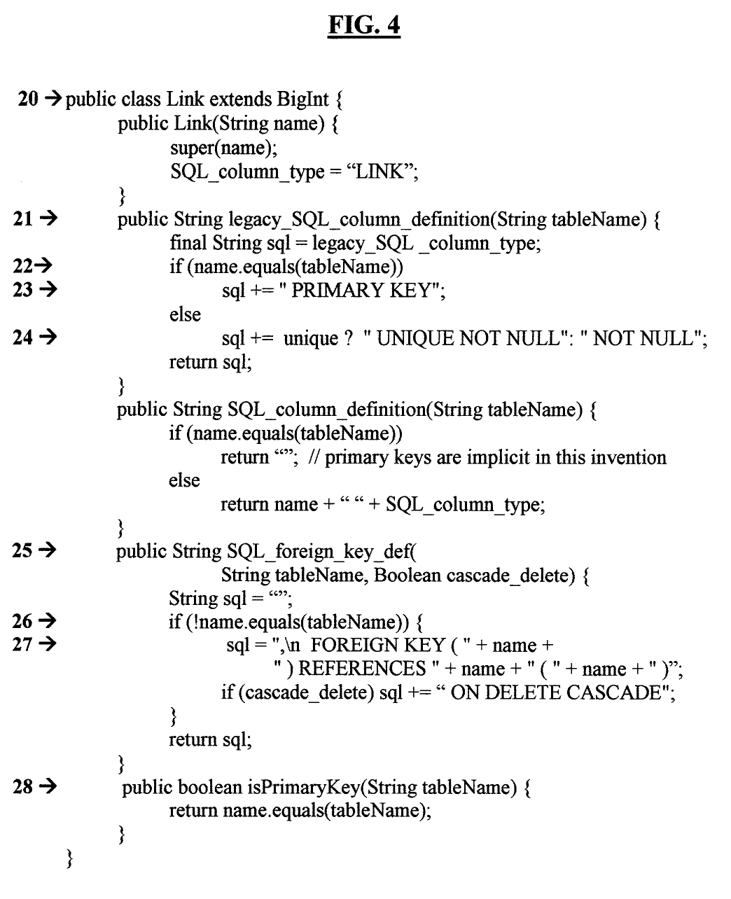

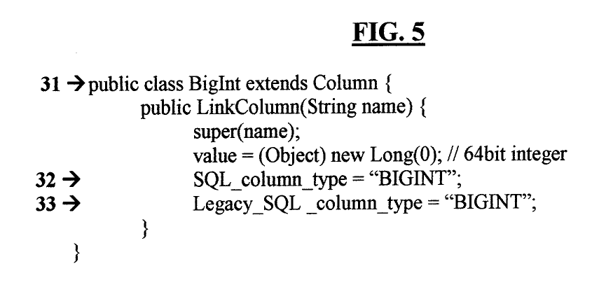

FIG. 4 is a detailed embodiment expressed in the language, Java, showing how Link 20 inherits from BigInt. FIG. 5 is a detailed embodiment expressed in the language, Java, showing how BigInt 31 is a subclass of Column. FIG. 3 is an embodiment of a Column metadata class 10, expressed in the language, Java.

The DDL parser of the prior art parses a vector of table column definitions and generates a vector of data structures, where each element of the vector is a data structure containing metadata about each column. An element of this generated vector is embodied in the class, Column 10 in FIG. 3. This invention adds software to the DDL parser of the prior art to scan the generated vector to determine the primary key, foreign keys and primary key referenced by each foreign key, based on the column type and column name.

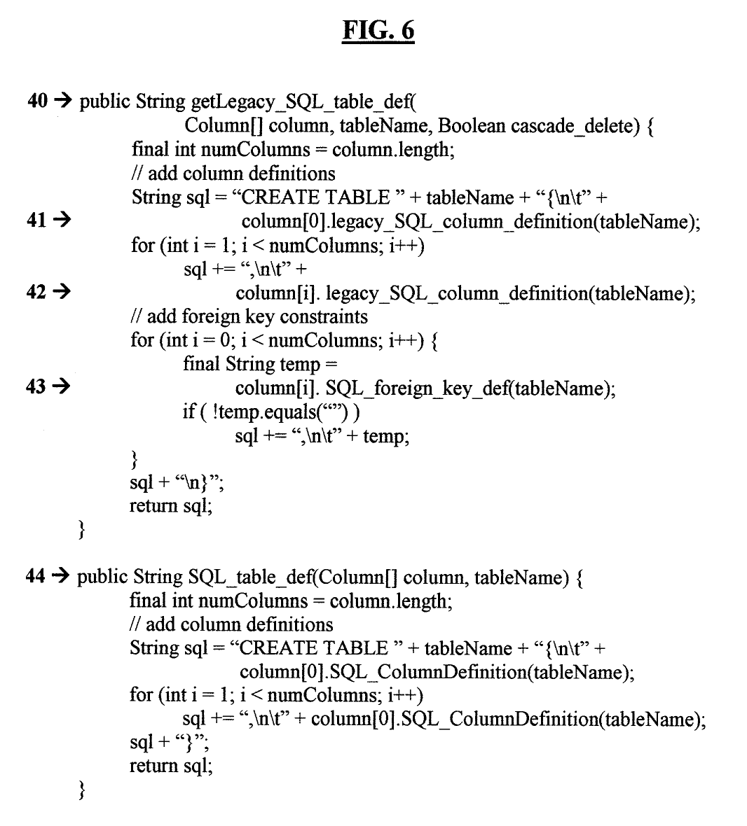

When the software is embodied as a front-end to an RDBMS of the prior art, then the method getLegacy_SQL_table_def 40 in FIG. 6 returns a SQL definition of a table compatible with the prior art. For each column, the column's legacy_SQL column_definition method at 41 and 42 returns the SQL definition of the column. When a column in the array is a link column, then legacy_SQL_column_definition returns the name of the column followed by “PRIMARY KEY”. Likewise, the method SQL_foreign_key_def 43 of a column returns the SQL definition of the foreign key if the column is a foreign key; otherwise an empty string is returned. The method SQL_table_def 44 returns a SQL definition of a table compatible with this invention.

The logic to return the primary key and foreign key definitions is in the Link class 20 of FIG. 4. The naming method is embodied in the Link class method, legacy SQL_column_definition 21. If the column name equals the table name 22, then the link column is a primary key 23; otherwise, the link column is a foreign key 24. SQL_foreign_key def 25 returns the definition of the foreign key using the embodied logic that if the link column name is not the same as the table name 26, then it is a foreign key 27. The generated legacy SQL table definition is next passed to the RDBMS of the prior art via the programming interface provided by the RDBMS and the RDBMS creates the table and associated metadata.

When the software of this invention is embodied as an embedded part of the RDBMS, the software is part of the RDBMS table generator, which translates the parsed vector of column definitions into the physical columns and metadata stored in the database. The same data structures and steps are used to identify the primary key, foreign keys and primary key referenced by each foreign key. The means of translation into tables and metadata is well understood in the prior art.

The prior art requires the option for people to create composite keys, because the current does not make a distinction between data columns and relational link columns. With the prior art, it might take a combination of multiple non-unique valued data columns to comprise the unique valued data used as the primary key. For example, a user might define the combination of first name and last name as the primary key in a personal address book. In this invention, a key column is always a single link column. Therefore, this invention does not use composite keys, which allows the constraint clause for composite primary and foreign keys to be removed from a DDL of the prior art. This makes a DDL much simpler and more concise.

The concept of a directed, relational link between tables is used extensively in entity-relationship (ER) models. The current ER modeling art generates a diagram from the metadata in a relational database, where the metadata explicitly identifies the primary and foreign keys and primary key referenced by each foreign key.

Likewise, there is prior art which allows ER diagrams to be automatically translated into table definitions in a SQL RDBMS. However, ER diagram syntax is a graphical DDL that still requires explicitly identifying the primary, foreign keys, and the primary key referenced by each foreign key in the diagrams prior to translation into tables in a relational database.

When this invention is applied to ER diagrams, the entity icons would no longer contain attributes naming the primary keys and foreign keys. Using this invention, the primary key and foreign key both are implicitly defined from the directed link connecting to entity icons. This invention makes ER diagrams simpler and more concise.

The prior art does not make a distinction between a data column and a column containing keys. Therefore, the prior art requires explicit specification of which data columns contain keys. The prior art lacks a means for implicitly inferring which columns contain keys.

Creating a column specifically for identifying the keys is obvious to anyone skilled in the art. This has not been implemented in the prior art because the inventors of the prior art valued the flexibility of allowing any data type to be used as a key value over what was perceived as the minor benefit of implicitly detecting the key columns.

What is not obvious is that a link column combined with an appropriate link column naming method eliminates the need to specify the lower level details of identifying the primary key, foreign keys and primary key referenced by each foreign key. Even less obvious is that this component enables the implementation of the other components of this invention, which guarantee RI, improve the speed of an RDBMS, and make the DDL and DML simpler and more concise.

The second component of this invention is a method and apparatus eliminating the need to specify the column corresponding to the primary key, comprising: the methods and apparatus of the first component of this invention and computer software that implicitly adds the primary key to a table definition.

Because the primary key can only be a link column and the column name is always the name of the table, there is no need to explicitly specify the primary key column as part of the table definition. Computer software implicitly adds the primary key column when a table is created in the database. Thus, this component eliminates the need for specification of a column corresponding to a primary key, which makes a DDL simpler and more concise.

The prior art already checks for the presence of a primary key in a table definition and signals an error if the primary key is not found. Instead of signaling an error, this invention would implicitly add a link column with the same name as the name of the defined table as described in more detail below.

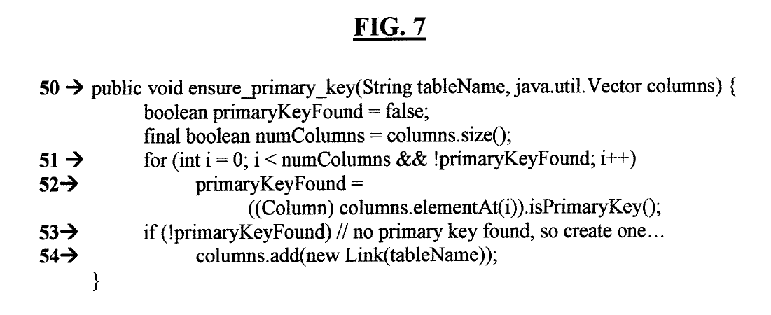

The embodiment of the software to implicitly create a primary key when one has not been specified is shown in FIG. 7 expressed in the language Java. It is envisioned that this software is part of a DDL parser. A DDL parser of prior art constructs a vector of column metadata elements which is passed to the method ensure_primary_key 50, which traverses each column metadata element 51 to check if it is a primary key 52. Each element in the vector is derived from the base class Column 10 in FIG. 3. The Column class provides the default method isPrimaryKey 16, which is overridden in FIG. 4 at 28 in the subclass Link 20. In FIG. 7, the method, isPrimaryKey 52, returns the values true or false, indicating if the vector element represents a primary key. If no primary was found 53, then it adds a new primary key metadata element to the vector of column metadata elements 54.

Using the example of assigning employees to departments, the AssignedEmployee table of this invention is expressed as:

------------------------------------------------------------------------------------------------------

CREATE TABLE AssignedEmployee {

Department LINK,
Employee LINK UNIQUE

}

------------------------------------------------------------------------------------------------------

Embodiment as layered software using the steps in FIGS. 3, 4, 5 and 6 would generate the following table definition compatible with a SQL RDMS of the prior art:

------------------------------------------------------------------------------------------------------

CREATE TABLE AssignedEmployee {

AssignedEmployee BIGINT PRIMARY KEY,
Department BIGINT NOT NULL,
Employee BIGINT UNIQUE NOT NULL,
FOREIGN KEY (Department)

REFERENCES Department (Department),

FOREIGN KEY (Employee)

REFERENCES Employee (Employee)

ON DELETE CASCADE

}

------------------------------------------------------------------------------------------------------

Note in the example above, that the prior art required about 5 times as much SQL code as this invention to define an equivalent table. In the example above, the AssignedEmployee table specified with this invention does not contain a column that would correspond to a primary key, because the primary key is implicitly created by the software of this invention. With this invention, a person simply specifies that an AssignedEmployee consists of a “link” to a Department and “link” to an Employee. There are no foreign key constraint clauses, which makes the definition simpler and more concise. This specification is a higher level of abstraction that does not require specifying the lower level details of primary key, foreign keys and primary key referenced by each foreign key.

The third component of this invention is a method and apparatus providing RI on row insert and row update without the need for RI constraint detection, checking and enforcement, comprising: the method and apparatus of the first component of this invention; the automatic assignment of a unique value to each and every primary key; not allowing any row update that would change the value of the primary key; only allowing the value of a foreign key to be set to the value of an implicit common column projected from a relational operation; setting an implicit not-NULL constraint on all foreign key columns.

The steps of this third component prevent user-defined data in primary and foreign keys, which is not practical in the prior art. The prior art does not make a distinction between columns containing user-defined data and columns containing relational links. For example, all primary keys having automatically generated values would not allow the user to assign a user-friendly part number for each product if that part number were a primary key. There are many similar cases where it would be necessary to allow assigning user-defined values in a primary key, when using the prior art.

However, the third component of this invention is practical when using the link columns of the first component of this invention, because the first component of this invention allows clear distinction between user-defined data columns and link columns. In this invention, the part number and primary key are always distinct. Thus, the part number can be set by a user to any desired value, while the value of the primary key never changes.

The prior art of specifying an attribute on an integer column to have automatically generated unique values is applied here to generate unique values for each and every primary key of this invention. For example, this method and apparatus is equivalent to the “GENERATE ALWAYS” column attribute of IBM Corporation's DB2 RDBMS.

Because every primary key is assigned a unique value, there is no need for a constraint check for uniqueness on insertion into a table. The prior art allowing user-defined values for primary keys must retain the overhead of the constraint check for uniqueness because the value of a primary key may or may not have already been checked for uniqueness.

In the prior art, the explicit “UNIQUE” and “NOT NULL” constraint attributes in SQL are implicitly specified on all primary key columns. Likewise, this same art of implicitly applying column attributes is used here to embody an implicit attribute of automatic generation of unique values on all primary keys and also embody an implicit not-NULL constraint on all foreign keys.

If the RDBMS does not have a means for automatically generating unique values for a primary key, then the software for generating a unique value can be embodied as front-end software to the RDBMS. The software uses a method of the prior art to generate a unique value and assign it to the primary key.

This component uses of prior art of not allowing a row update if the update would change the value of the primary key. In the prior art, when no RI constraint is specified on row deletion, then an implicit “no action” constraint is placed on a foreign key, which does not allow update of a primary key if there are any foreign keys referencing the primary key. Because this invention never applies constraints on foreign keys, update of a primary key is never allowed.

The prior art applies this restriction of not allowing primary key updates selectively by requiring it to be explicitly specified when desired. However, this invention implicitly applies this restriction for all cases. Not allowing update of primary keys in all cases is not practical in the prior art, because the prior art does not make a distinction between columns containing user-defined data and columns containing relational links. For example, one might wish to change the user-defined department name, where the department name is also a primary key for the Department table.

However, this invention's clear distinction between columns containing user-defined data and columns containing relational link information, allows the link information in a primary key to be immutable while still providing the flexibility of changing the department ID number. Because the primary key of this invention is always immutable, RI constraint checking and enforcement associated with changing the value of a primary key is eliminated, which improves database performance.

This invention's software enforces that a foreign key value is only set via a common column projected by a relational operation, by adding software instructions to the DML parser that checks each explicit assignment statement to ensure the assignment is not to a link column. The prior art already checks validity of assignment based on type checking and value range checking. Thus, it is well understood in the art how to enforce this assignment constraint.

In the prior art, all relational operations generate a new table, which can be used in other relational operations. In this invention, each link column of the generated table is made implicitly common with the link column of the same name in a row that will be inserted or updated. The art of detecting and using implicit common columns to restrict values is well understood in the prior art.

Setting the value of a foreign key to the value of an implicit common column returned by a relational operation combined with the not-NULL constraint on foreign keys ensures that an inserted or updated foreign key will always reference a valid primary key. The immutability of the primary key guarantees no foreign keys can be orphaned by a change in the primary key. Thus, there is complete RI on all row inserts and updates. Because the restrictions of this component guarantee RI, there is no need for the RI constraint detection, checking and enforcement of the prior art.

There are many patents on detecting, checking and enforcing RI constraints. This invention makes those inventions irrelevant, because this invention eliminates the need for RI constraint detection, checking and enforcement for all row inserts and row updates. Eliminating the overhead of constraint detection, checking and enforcement produces much better RDBMS performance.

The fourth component of this invention provides RI on row deletion without specifying RI constraints on each foreign key, comprising: the first component of this invention; a not-NULL constraint on all foreign keys; adding a table-level cascade delete constraint attribute to the definition of a table; and row deletion maintaining RI.

This fourth component of this invention is a paradigm shift from the prior art. The prior art is column constraint-oriented, where explicitly specified RI constraints are placed on the columns comprising the foreign key.

The prior art of SQL allows a user to specify either an “ON DELETE CASCADE” or “ON DELETE SET NULL” constraint specification on the foreign key. When no RI constraint is specified on row deletion, then an implicit “no action” constraint is placed on a foreign key, which does not allow update of a primary key if there are any foreign keys referencing the primary key.

This fourth component of this invention is table constraint-oriented, where a single constraint attribute is placed on the parent table and the specified constraint is implicitly applied to all the child tables. The paradigm of this invention eliminates the potential for the human error of forgetting to specify required constraints on some foreign keys. The same prior art that implicitly applies a not-NULL constraint on all primary keys is used here to implicitly apply a not-NULL constraint on all foreign keys.

A table-level constraint is not possible in the prior art, because the prior art allows a foreign key to have a NULL value. Thus, when a row is deleted in a parent table of the prior art, a dependent row may either be deleted or the dependent row's foreign key set to a NULL value if RI is to be maintained. The prior art requires specifying either an “ON DELETE CASCADE” or “ON DELETE SET NULL” constraint on each foreign key to maintain RI when a row in the parent table is deleted. In contrast, this invention does not allow NULL valued foreign keys. Therefore, there is only one constraint that can be applied on each foreign key of this invention, which can be summarized as a single, table-level cascade delete constraint on the parent table.

A table-level cascade delete constraint on a table is embodied as cascade delete constraint syntax in a DDL of the prior art and a DDL parser that recognizes the table-level cascade delete constraint syntax.

FIG. 1 is an embodiment of a SQL DDL table definition expressed in BNF for declaring use of a table-level cascade delete constraint 1. The SQL “ON DELETE CASCADE” and “ON DELETE SET NULL” constraints on a foreign key of the prior art are absent from this DDL, because those constraints are not needed.

The software of this invention uses the prior art of DDL parsers to parse the table definition with the extended syntax as shown in FIG. 1 for specifying cascade delete 1. It is well understood in the art how to add recognition of a new attribute such as “ON DELETE CASCADE” to a parser of the prior art.

This fourth component further comprises computer software instructions implementing the steps of: saving a Boolean cascade delete attribute in the metadata tables of an RDBMS for each table in the database, wherein the parsed detection of a cascade delete attribute in the definition of a table causes the cascade delete attribute saved in the RDBMS metadata table to be set to the Boolean value of “true” and otherwise, the metadata attribute is set to “false”.

The current RDBMS art maintains at least one metadata table that tracks attributes for each table. A metadata table contains a row of table attributes. The prior art is used to add one more column of Boolean attributes to that table indicating whether cascade delete should be applied on deletion of a row in that table cascades to any child tables. The software uses the programming interface to the RDBMS to save a Boolean metadata attribute in a metadata table of the RDBMS.

In the prior art, an integer metadata attribute exists in the RDBMS for each foreign key indicating whether deletes in the parent table: 1) cascade to the child table, 2) set the foreign key to NULL, or 3) a no-action constraint exists that disallows a delete in the parent table when dependent rows in the child table exists. With this invention, there is only one Boolean metadata attribute indicating whether cascade delete should be done, which is associated only with the parent table. RDBMS performance is improved because run-time checking of constraints only requires checking a single constraint on the parent table rather than checking constraints on each foreign key in the child tables.

When this software is embodied as a front-end to an RDBMS, the table-level cascade delete constraint of this invention can be translated to foreign key constraints of the prior art as embodied in the software listings in FIGS. 3, 4 and 6, where the Boolean cascade_delete parameter to the method SQL_foreign_key_def in FIG. 4 at label 25 is used to set the “ON DELETE CASCADE” attribute on a foreign key. The value of the cascade_delete parameter is set by querying the RDBMS for the for the parent table's Boolean cascade delete attribute in the metadata using methods of the prior art and passing the cascade delete value from the RDBMS through the cascade_delete parameter to SQL_foreign_key_def 25.

When a user requests that a row be deleted from a table, this embodiment uses the following software algorithm: determine if cascading delete is allowed by querying an RDBMS for the metadata about the table containing the row to be deleted; determine the child tables of the table containing the row to be deleted by querying an RDBMS for the metadata about the table's child tables; search the identified child tables to locate any dependent rows in the child tables; if cascading delete is allowed on the table containing the row to be deleted, then this software instructs the RDBMS to delete the row and also delete every located dependent row in the child tables; if cascading delete is not allowed on the table containing the row to be deleted and no dependent rows exist in the child tables, then this software instructs the RDBMS to delete the row; otherwise, the software uses the prior art to signal an error. The means for searching metadata, finding and deleting dependent rows, and signaling errors are all well understood in the prior art.

The preferred embodiment is that deletion of a row in a parent table is not cascaded to child tables unless specified otherwise. It is envisioned that a variation of the preferred behavior be that deletion of a row is cascaded unless specified otherwise. In that case, the software would require the user to specify as part of the parent table definition that cascading delete should not be done.

U.S. Pat. No. 5,226,158 of Horn and Malkemus teaches a method of detecting the validity of new RI constraints when a child table is added with a cascade delete constraint on its foreign key. For example, if a child table is added that contains a foreign key with a cascade delete constraint and the foreign key of another child table does not have a constraint, then the cascade delete constraint on the new child table is inconsistent and requires signaling an error condition.

With this component, there is no need for the RI constraint detection and validation of Horn and Malkemus when new child tables are added because the method ensuring RI is specified on the parent table and is automatically applied to all foreign keys in a consistent manner. By eliminating the overhead of the RI constraint validation when new child tables are added, RDBMS performance is improved.

It is the combination of the above four components of this invention that eliminates the explicit specification of primary keys, foreign keys, and RI constraints on foreign keys. Thus, the combination of the above components make it possible for a less skilled database designer to create relational databases having logical consistency of data without having to understand the concepts of primary key, foreign key and RI constraints. This is not possible in the prior art.

The fifth component of this invention is a method and apparatus providing a simpler and more concise DML for database queries comprising: the methods and apparatus of the first component of this invention and the step of all link columns with the same name are implicit common columns in all relational operations and all derived relational operations.

In the prior art, always applying implicit common columns to a relational operation is not possible, because two columns of the same name and type can not be assumed to be common columns. For example, an employee ID is probably not the same as a department ID. Thus, an integer “ID” column in an Employee table should not be made implicitly common with the integer “ID” column in the Department table.

In contrast, two link columns of this invention with the same name are defined by the first component of this invention to always be common columns. The SQL “SELECT” example below lists the employees assigned to each department using this invention:

SELECT Department.Name, Employee.FirstName, Employee.LastName

FROM Department, AssignedEmployee, Employee

Whereas, the SQL equivalent using the prior art is more complex and less concise:

SELECT Department.Name, Employee.FirstName, Employee.LastName

FROM Department, AssignedEmployee, Employee

WHERE Employee.ID=AssignedEmployee.EmployeeID, Department.ID=AssignedEmployee.DepartmentID;

In the example above, this invention allows the link column Department.Department to be implicitly common with AssignedEmployee.Department and the link column Employee.Employee to be implicitly common with AssignedEmployee.Employee. Applying implicit common columns to all link columns in all relational operations makes all database query statements simpler, more intuitive and concise than the prior art.

The prior art selectively applies implicit common columns on the relational operations: union, intersect, difference, and some join operations. For example, the union operation in the prior art uses implicit common columns when two tables have the same number of columns and each corresponding column is of the same data type. In contrast, the prior art does not use implicit common columns for product operations unless explicitly specified. This invention applies the prior art of implicit common columns for link columns on all relational operations and derived relational operations such as the product operation.

The sixth component of this invention is a method and apparatus providing simpler and more concise DML for inserting, updating and deleting rows in a table comprising: the methods and apparatus of the fifth component of this invention and the step of all relational operations implicitly projecting all the link columns.

The prior art only projects explicitly selected columns as the result of the relational operation, projection. In SQL, the “SELECT column_list FROM table_list” statement performs a relational projection operation, where “column_list” is an explicit list of which columns should be projected into the table derived from a relational operation. This invention also implicitly projects all link columns along with the explicitly projected columns. The software steps to implement this are: test if the column is explicitly selected or is a link column; if the column is explicitly selected or is a link column, then project the column as part of the result of the relational operation.

The method and apparatus to project the link column uses the same art used to project an explicitly selected column. The fifth component of this invention, which contains the second component of this invention, only allows the value of foreign key to be set via implicit common column. The projected link columns are made implicitly common with the foreign keys of a row to be inserted, updated or deleted using the implicit common columns of the fifth component. This makes DML statements for inserting, updating and deleting rows simpler, more intuitive and more concise.

The following example shows how to insert a new row using the sixth component of this invention. This example, based on the previous example that defined the AssignedEmployee table, inserts a row indicating an assignment of an employee to a department:

INSERT INTO AssignedEmployee

SELECT ALL FROM Employee, Department

WHERE Employee.FirstName=“Mike” AND Employee.LastName=“Lopez” AND Department.Name=“Engineering”;

The SQL equivalent using the prior art is less concise.

INSERT INTO AssignedEmployee (EmployeeID, DepartmentID)

SELECT Employee.ID, Department.ID FROM Employee, Department

WHERE Employee.FirstName=“Mike” AND Employee.LastName=“Lopez” AND Department.Name=“Engineering”;

The primary key, “AssignedEmployee.AssignedEmployee” is automatically assigned a unique value in both this invention and the prior art. This invention makes the implicitly projected “Employee.Employee” column implicitly common with “AssignedEmployee.Employee” and makes the implicitly projected “Department.Department” column implicitly common with “AssignedEmployee.Department”. Next, the row is inserted. The implicit projections make the DML simpler and more concise.

As with the fifth component of this invention, using implicit common columns in the prior art is not possible because two columns of the same name and type can not always be assumed to be common columns. Therefore, the mapping in the prior art must always be explicit, which makes the DML statements less concise. Further, because the prior art allows user-defined values for foreign keys, the potential for orphan rows exists.

Although the present invention has been described in accordance with the embodiments shown, one of ordinary skill in the art will readily recognize that there could be variations to the embodiments and those variations would be within the spirit and scope of the present invention. For example, it is envisioned that the software can be implemented in any programming language and does not have to use the same data structures and algorithms as described here to achieve the same effect. The database could be any kind of database supporting relational constructs and is not limited to relational databases. Further the table definition and data manipulation languages may be textual such as SQL, graphical languages, or software data structures. Accordingly, many modifications may be made by one of ordinary skill in the art without departing from the spirit and scope of the appended claims.

What is claimed is:

1. A method and apparatus for implicitly identifying within the definition of a relational database table specified in a data definition language (DDL) the primary key, zero or more foreign keys and the primary key referenced by each foreign key, comprising:
a) a new table column type, herein referred to as a link column, which only contains keys;
b) a link column naming method;
c) computer software using said link column type and said link column naming method to identify within a table definition expressed in a DDL the primary key, zero or more foreign keys, and the primary keys referenced by each foreign key;

2. The link column of claim 1, further comprising:
a) a DDL containing a link column type identifier;
b) a DDL parser using the syntax and semantics of said link column;
c) the link column type extending a binary integer column type used by a relational database management system (RDBMS), such that the integer fields of a column each contain a sufficient plurality of binary bits to be assigned a unique value for each and every field in the column;

3. The link column naming method of claim 1, further comprising the steps of:
a) a link column containing primary keys is assigned the same name as the name of the table containing said column;
b) a link column containing foreign keys is assigned the same name as the name of the link column containing the referenced primary keys;

4. The computer software of claim 1, further comprising:
a) a vector of column metadata created by a DDL parser;
b) software instructions comprising the steps of: iterating over each element of said vector wherein for each element in said vector, software instructions identify the type of column, where: if the column type is a link column, then: if the name of said column is the same name as the name of the table containing said column, then said column is identified as a primary key; if the name of said column is not the same name as the table containing said column, then said column is identified as a foreign key referencing a primary key having the same name as the foreign key;

5. A method and apparatus to not require specification of the table column that is the primary key of a table, comprising:
a) a vector of column definitions contained within a table definition, which is created by a DDL parser;
b) software instructions to iterate over each element of said vector to locate a column definition specifying a link column with the same name as the name of said table containing said column definition; if a said link column definition is not found, then a data structure defining a link column with the same name as the name of said table is created and appended to said vector;

6. A method for maintaining referential integrity on all row inserts and all row updates, comprising the method and apparatus of claim 1 and further comprising the steps of:
a) automated assignment of a unique value to each and every primary key;
b) not allowing any row update that would change the value of the primary key;
c) only allowing the value of a foreign key to be set to the value of an implicit common column projected from a relational operation;
d) setting an implicit not-NULL constraint on all foreign key columns;

7. A method for maintaining referential integrity on row deletion in a relational database table, comprising:
a) the method and apparatus of claim 1;
b) the step of setting an implicit not-NULL constraint on all foreign key columns;
c) a table-level cascade delete constraint syntax added to a DDL and DDL parser;
d) computer software that saves a Boolean cascade delete constraint attribute for each table in the database in the RDBMS metadata, wherein the parsed detection of a cascade delete constraint in the definition of a table causes the cascade delete constraint attribute in the RDBMS metadata table to be set to the Boolean value of true and otherwise, said constraint metadata attribute is set to the Boolean value of false;
e) row deletion maintaining referential integrity (RI);

8. The row deletion maintaining RI of claim 7, further comprising software instructions which:
a) determine if cascading delete of dependent rows in child tables of a parent table is allowed by querying an RDBMS for the metadata about the parent table containing a row to be deleted;
b) determine the child tables of said parent table by querying said RDBMS for the metadata about said parent table;
c) search said child tables to locate any dependent rows;
d) if cascading delete is allowed on said parent table, then said software instructs said RDBMS to delete said row and delete any and all located dependent rows in said child tables;
e) if cascading delete is not allowed on said table and no dependent rows exist in said child tables, then said software instructs said RDBMS to delete said row; otherwise if dependent rows exist in said child tables then said software signals an error condition;

9. A method and apparatus providing a simpler and more concise data manipulation language (DML) for relational database query statements, comprising the method and apparatus of claim 1 and further comprising the step of all link columns with the same name are implicit common columns in all relational operations;

10. A method and apparatus providing a simpler and more concise DML for row insert, row update and row delete statements, comprising: the method and apparatus of claim 9; and the step of all relational operations implicitly projecting all the link columns.
